(19) United States
(12) Patent Application Publication
(10) Pub. No.: US 2024/0052684 A1
(43) Pub. Date: Feb. 15, 2024

(54) METHOD FOR OPERATING A DOOR SYSTEM AND DOOR SYSTEM THEREFOR

(71) Applicant: dormakaba Deutschland GmbH, Ennepetal (DE)

(72) Inventors: Alexey Kurkov, Ennepetal (DE); Jonas Kirschner, Ennepetal (DE); Dennis Meiering, Ennepetal (DE); Patrick Winkelmann, Ennepetal (DE)

(21) Appl. No.: 18/363,452

(22) Filed: Aug. 1, 2023

(30) Foreign Application Priority Data
Aug. 12, 2022 (EP) 22190237.2

(51) Int. Cl. E05F 15/73

(52) U.S. Cl. CPC E05F 15/73; E05Y 2400/44; E05Y 2900/132

(57) ABSTRACT

A door system with a door actuator, includes at least one door leaf, and a sensor unit configured and connected to a control unit of the door system, with the approach of an object to the door system within a detection region being detected by the sensor unit, in particular designed as a radar sensor or as a camera. The method includes at least the following steps: determining for the first time at least one first object position of the object within the detection region, determining for the second time at least one subsequent second object position of the object within the detection region, calculating an object vector based on the determined first and second object positions and opening the at least one door leaf depending on the properties of the calculated object vector. A door actuator for carrying out the method and a computer program product are also related.

### CROSS-REFERENCE TO RELATED APPLICATIONS

This application claims the benefit of European patent application 22190237.2, filed on 12 Aug. 2022, the disclosure of which is incorporated herein by reference in its entirety.

### TECHNICAL FIELD

The disclosure relates to a method for operating a door system with a door actuator, with the door system having at least one door leaf, and with a sensor unit being configured and connected to a control unit of the door system, with the approach of an object to the door system within a detection region being detected by means of the sensor unit, in particular designed as a radar sensor or as a camera.

### BACKGROUND

For example, EP 3 613 933 A1 discloses a method for operating an automatic door system which has a door actuator connected to a door leaf. It is indicated here that radar movement detectors are used to actuate the door movement for automatic sliding doors. For swing leaf doors, radar sensors are not common for detecting monitored regions if the sensors ultimately detect objects, in particular in the form of people, and transmit corresponding data to a control unit to control the door system.

DE 196 13 178 A1 discloses a method for operating an automatic door system, and the door system can have a door leaf that can be actuated via a door actuator. Furthermore, sensor units are proposed which cooperate with a control unit and the control unit can be actuated using sensor data such that the door system is optimally operated.

### SUMMARY

The disclosure is therefore the further improvement of a method for operating a door system, in which the determination of the movement behavior of the object is simplified. In particular, the approach of the object to the door system within a detection region should be simplified.

This is achieved by proceeding from a method for operating a door system according to claim 1, proceeding from a door actuator according to claim 12, proceeding from a door system according to claim 13 and proceeding from a computer program product according to claim 14 with the respectively characterizing features. Advantageous further developments of the disclosure are each indicated in the dependent claims.

According to the disclosure, the method provides at least the following steps: determining for the first time at least one first object position of the object within the detection region, determining for the second time at least one subsequent second object position of the object within the detection region, calculating an object vector based on the determined first and second object positions and opening the at least one door leaf depending on the properties of the calculated object vector.

The core idea of the disclosure is the mere use of at least two detected object positions within the detection region of the sensor unit, such that an object vector can be created based on the two object positions. Mathematically, it is possible to create a vector with two object positions, since a straight line can be drawn through the two object positions, which are to be regarded mathematically as a point in space and preferably as a point on a plane, or a line of defined length and direction can be determined between the object positions, which can define an object vector. Not only a length but also a direction of the object vector can be determined by the time sequence from the detection of the first object position to the subsequent detection of the second object position, with the length of the object vector being able to be defined via the distance-time law. In this respect, all attributes that are required for the complete determination of an object vector, at least in one plane, are already provided by the detection of two object positions. The subsequent opening of the at least one door leaf of the door system takes place depending on the properties of the object vector calculated below. The object vector is thereby preferably and in particular calculated using the control unit, while the sensor unit can only supply the information about the object positions to the control unit.

The determination of the first and second object position is provided based on the raw data of the sensor units, as it can be output by the sensor units in the simplest and raw form. The determination of the first and second object position can thereby take place in the sensor unit or in the control unit of the door system or in cooperation of both units.

By carrying out this very simple method, it is possible to provide object vectors with low computing power and high computing speed, such that the opening characteristics of the at least one door leaf can be determined with a subsequent algorithm. As a result, the hardware and/or software configuration of the control unit can be greatly simplified. The result times for the actual opening of the at least one door leaf can thus be shortened further.

It is conceivable that the object vector is calculated in such manner that further object positions are used for the calculation, namely in addition to the first and second object positions. It is thus possible to use a total of three to seven, preferably four to six, in particular five, object positions to calculate the object vector. A more precise determination of the object vector is thus possible.

The opening of the at least one door leaf is determined with particular advantage using different opening parameters. In this way, opening can be determined with an opening width and/or with an opening speed and/or at a specific opening time and/or with a specific opening hold time, i.e. a subsequent closing time. If the door system has more than one door leaf, the parameters for moving the respective door leaf can also deviate from one another.

The sensor unit is preferably equipped with a radar sensor, with the sensor unit also comprising further sensor devices, or the sensor unit itself being provided by a radar sensor. It is also conceivable that the sensor unit consists of a radar sensor unit without further sensors.

In particular, raw data is recorded with the sensor unit, preferably having a number of points in a point field, with the determined first and second object positions being determined from the raw data by means of a computer unit of the sensor unit or the control unit, in particular with the control unit carrying out the calculation of the object vector from the at least two object positions. The raw data of the sensor unit can also comprise a point cloud, such that the two object positions are determined in chronological sequence, for example from geometric or statistical center points of the point cloud, in particular by so-called clustering. In this way, action limits can also be defined such that pixels that are clearly outside the center of gravity of a point cloud are not considered. In this way, the two object positions can be determined in chronological sequence from a large number of individual pixels, with the determination preferably being carried out with the control unit, while the sensor unit only transmits the raw data in the form of the pixels, in particular the large number of pixels, to the control unit, with the pixels also being able to be pre-filtered, for example by means of the sensor unit.

The points in the point field can be understood as points in a plane.

In particular, the raw data can thereby be assigned to a specific object by means of a computer unit, the sensor unit or the control unit. This is called clustering. The clustering can thereby be carried out using a method known from the state of the art, for example DB SCAN (density-based spatial clustering). It can thus be ensured that the object positions determined thereafter and/or the object vector calculated thereafter relates to a specific object. In particular, the determined object positions can be assigned to a specific object, in particular provided with an object ID, such that the object vector calculated thereafter also relates to a specific object.

In particular, the first and/or the second object position can be determined from a maximum of 10 to 50, preferably from a maximum of 20 to 40, particularly preferably from 30 raw data items, in particular points lying in one plane. The first and/or the second object position can preferably be determined from raw data, in particular points lying in one plane, which have a lifetime from the time of receipt of a maximum of 200 ms to 600 ms, preferably 300 ms to 500 ms, particularly preferably 400 ms. Older raw data can thereby be deactivated or deleted. This enables efficient data reduction with sufficient security.

For example, it is advantageous if the sensor unit does not have its own processor unit with which the data is prepared for transmission to the control unit, such that the control unit itself can run the algorithm in order to determine the object positions from an in particular large number of raw data items or points. The object position is thereby subsequently determined in chronological sequence, for example with a type of sampling rate, such that the defined object vector can be determined as a moving object vector, in particular in the direction of the door system. The object vector is nevertheless defined continuously from the first and second object positions, between which the object vector is defined.

Advantageously, only two-dimensional raw data is recorded with the sensor unit; in particular, the recorded raw data is further processed as two-dimensional data, in particular comprising a number of points in a point field. Dispensing with three-dimensional raw data and in this respect the recording of three-dimensional data, achieves the advantage that the amount of data recorded and to be processed is significantly reduced. This reduction also leads to a simplification of the control process of the door leaf of the door system, requires less hardware and allows the use of simplified software, and the method can be carried out faster.

Alternatively, it is also possible for three-dimensional raw data to be recorded, but the data can be reduced to two-dimensional raw data by means of the sensor unit or by means of the control unit or by means of the computer unit, in particular before the object positions are determined.

In this way, the control unit can also carry out the calculation of the object vector from only two-dimensional raw data, in particular comprising pixels lying in one plane.

The door system has at least one door leaf, which is designed as a rotary leaf and performs a pivoting movement, or it is also conceivable that at least one door leaf is provided, which is designed as a sliding door leaf and performs a linear sliding movement when the door leaf is moved by means of the opening step.

In particular, the opening step of the door leaf is only carried out if the second object position is closer to the door leaf than the first object position, such that the object vector calculated therefrom consequently points in the direction of the door system. A sensor unit that has at least one radar sensor is in particular advantageous for carrying out the method, since points of an object and, to that extent, object positions can be detected particularly advantageously with a radar sensor.

The detection region, which is spanned by the sensor unit in front of and in particular behind the door system, can span a rectangular, semicircular or trapezoidal base area, and, according to a further configuration of the method according to the disclosure, deactivation data for deactivating the detection of at least one defined region of the detection region is provided to the sensor unit by means of the control device. It is conceivable that the defined region, in particular the hidden region, is formed around the door leaf in order to prevent self-detection of the door leaf by the sensor unit.

Alternatively or additionally, it can be provided that the control device itself filters out the object data of the sensor unit in a defined region of the detection region, i.e. ignores it in this respect, in order to create a hidden region. Such a hidden region can be provided, for example, if certain regions within the detection region are not supposed to trigger the opening of the door leaf, or the hidden region is supposed to lead to a different opening characteristic of the movement of the door leaf. It is also in particular provided that the hidden region is formed around the door leaf in order to prevent self-detection of the door leaf by the sensor unit. The prevention of such a self-detection of a door leaf is in particular important in door systems with a plurality of door leaves, since the door leaves can mutually move into their detection regions of the associated sensor units, which results in a stop function or a reversal of the movement of the door leaf, for example. Such a malfunction of the movement of the door leaves can be avoided by creating hidden regions that are calculated in particular with the control device and the associated method.

With regard to the parameterization of the movement of the door leaf, it can be provided that the maximum opening width and/or the maximum opening speed and/or the opening time and/or the opening hold time or the subsequent closing time is determined by the control unit depending on the recorded approach angle of the object vector. Additionally or alternatively, it can be provided that the opening speed of the door leaf is determined to be lower when the object approaches the door system from the direction of the closing side than when the object approaches the door system from the direction of the hinge side. Conversely, this also means that the opening speed of the door leaf is determined to be greater when the object approaches the door system from the direction of the hinge side than when the object approaches the door system from the direction of the closing side.

Features and details, which are described in connection with the method according to the disclosure and the door actuator according to the disclosure, also apply in connection with the door system according to the disclosure and vice versa.

The disclosure is also aimed at a door actuator of a door system for carrying out the method. Furthermore, the disclosure is aimed at a computer program product for carrying out the method and/or for operating the door actuator.

Features and details, which are described in connection with the method according to the disclosure and the door actuator according to the disclosure as well as the door system according to the disclosure, also apply here in connection with the computer program product according to the disclosure and vice versa.

### BRIEF DESCRIPTION OF THE DRAWINGS

Further measures that improve the disclosure will be outlined in greater detail below together with the description of a preferred exemplary embodiment of the disclosure on the basis of the figures, in which is shown:

FIG. 1 a schematic view of the door system with an object moving perpendicularly towards the door system, and the door leaf has been opened by 75° as an example,

FIG. 2 the arrangement of the door system according to FIG. 1 in a top view, with the object entering the door system obliquely from the closing side and the door leaf being opened by 45°, for example,

FIG. 3 a door system with sliding leaves, with the object approaching the door system in the middle and perpendicular thereto,

FIG. 4 the door system with sliding leaves according to FIG. 3, with the object approaching the door system at an angle,

FIG. 5 a side view of the door system with an object on the approach side and with an object on the exit side,

FIG. 6 the door system with a detection region having two hidden regions, and

FIG. 7 a schematic sequence of the method steps according to the disclosure.

### DETAILED DESCRIPTION OF THE DRAWINGS

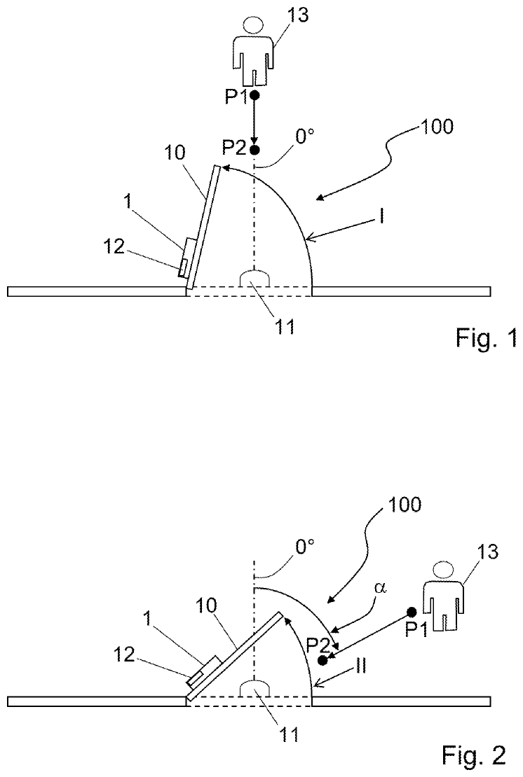

FIGS. 1 and 2 each show a door system 100 with a door leaf 10 which can be pivoted by means of a door actuator 1. For this purpose, the door leaf 10 has a hinge side, which is shown on the left side of the door leaf 10 and forms the pivot point of the door leaf, and the free side of the door leaf 10 forms the closing side, which has a fitting of the door leaf 10 in a manner not shown in detail. FIG. 1 thereby shows the door leaf 10 with a first opening width I, which is 75°, for example, and FIG. 2 shows the door leaf 10 with a second opening width II, which is 45°, for example. The door leaf 10 is therefore located in the closed position in a 0° position.

FIG. 1 shows an object 13 which is moving perpendicularly towards the door system 100. This vertical position forms an approach angle of 0°, whereas FIG. 2 shows the object 13 approaching the door system at an approach angle α, for example 30°.

The object 13 is assigned an object vector V, which is determined using two object positions P1 and P2. The object positions P1 and P2 are determined using the control unit 12 of the door system 100, which is designed in particular as a component of the door actuator 1, which in turn is part of the door system 100. After the first object position P1 of the object 13 and subsequently the second object position P2 of the object 13 have been detected with the sensor unit 11, the opening of the door leaf 10 is carried out based on the calculated object vector V.

By way of example, the comparison of FIGS. 1 and 2 shows that when an object 13 approaches obliquely from the hinge side, the door leaf 10 does not open as wide as when an object 13 moves perpendicularly towards the door system 100, i.e. from the direction of 0°. It is provided, for example, that the approach angle α of the object 13, for example a person, is detected with a sensor unit 11, and the approach angle α forms the angle of the person to the perpendicular direction of 0°, at which the person approaches the door system obliquely, the method also provides that the door leaf 10 opens either with the first opening width I or with the second opening width II, which depends on the detected approach angle α. In addition, a first or second opening speed can be provided when opening the door leaf 10, with the opening speed having a greater value in the case of a larger first opening width I than in the case of a smaller second opening width II.

Alternatively, the opening speed and/or the opening time and/or the opening hold time or the subsequent closing time can therefore also be calculated in a specific manner based on the object vector V.

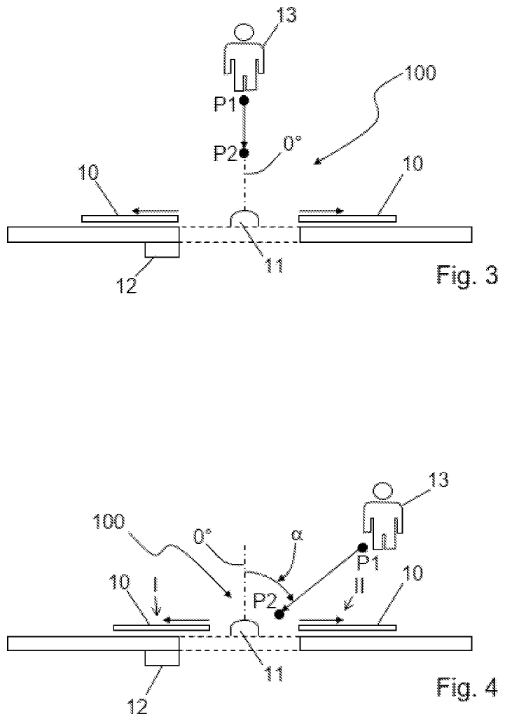

FIGS. 3 and 4 each show door systems 100 with door leaves 10 designed to be movable in a sliding manner, and the movement of the door leaves 10 is controlled via the control unit 12. The sensor unit 11 is shown by way of example only on an approach side of the door system 100; it can also be present on the exit side of the door system 100 in the same way.

In FIG. 3, the object 13 approaches the door system 100 from the perpendicular, shown at the angle 0°, and the two door leaves 10 open by the same distance and at the same speed. In the same way, first the first object position P1 and then the second object position P2 are detected with the control unit 12, and then the object vector V is determined with the control unit 12, on the basis of which the opening of the door leaf 10 is carried out.

In FIG. 4, the object 13 is approaching at an angle α to the perpendicular of 0°, and the example shows that the door leaf 10 on the approach side of the object 13 is opened wider than the door leaf 10 on the side facing away from the approach side. In this case, of course, the door leaf 10 on the left side facing away from the approach can still open by a certain distance, and the door leaf 10 on the right side does not have to open completely either. The opening widths of both door leaves 10 ideally release a passage section of the movement path of the object 13 as it passes through the door system 100. As an example, the left door leaf 10 thereby shows the smaller first opening width I and the right door leaf shows the larger second opening width II.

The movement of the door leaves 10 is controlled via the control unit 12, which is electrically connected to the at least one sensor unit 11 in a manner not shown in detail. The sensor unit 11 is, for example, a radar sensor or a camera that is not only able to detect the presence of the object 13, but the sensor unit 11 can also detect the distance of the object 13 from the door system 100 and the angle α at which the object 13 approaches the door system 100. In addition, a radar sensor or a camera with corresponding image evaluation can determine the approach speed of the object 13.

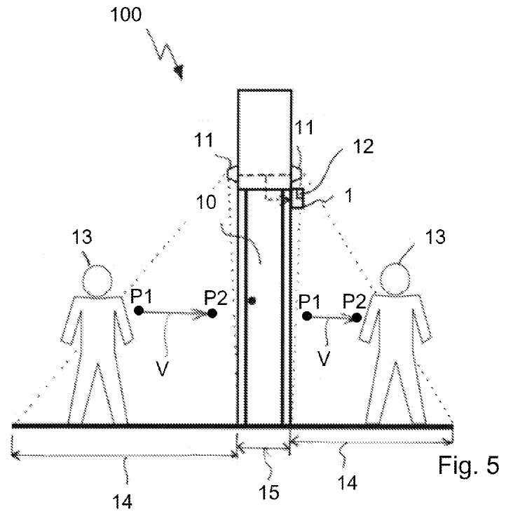

FIG. 5 shows a door system 100 with a door actuator 1 for actuating a door leaf 10, and a sensor unit 11 is arranged on both sides of the door system 100. One detection region 14 can be recorded in each case with the sensor unit 11 such that objects 13 that are located within the detection region 14 can be detected with the sensor units 11. Between the two detection regions 14, in particular directly within or below the door system 100 and the door leaf 10, there is an inner region 15 which cannot be monitored with the sensor units 11.

According to the disclosure, the sensor units 11 are designed such that an object vector V is determined on the basis of the object positions P1, P2 detected with the sensor units 11. Here, too, the object vector V forms the parameter for the opening widths I, II, with which the door leaf or leaves 10 are to be opened; likewise, the opening speed of the door leaf 10 can be determined using the parameter based on the object vector V. According to the disclosure, the object vector V can thereby be formed starting from the detection region 14 on the approach side to the end of the detection region 14 on the exit side of the door system 100. The inner region 15, which cannot be recorded with the sensor units 11, can be additionally determined by calculation. Consequently, a continuous, single object vector V can be determined from the two individual object vectors V shown as an example, which is calculated in real time for each section of the entry.

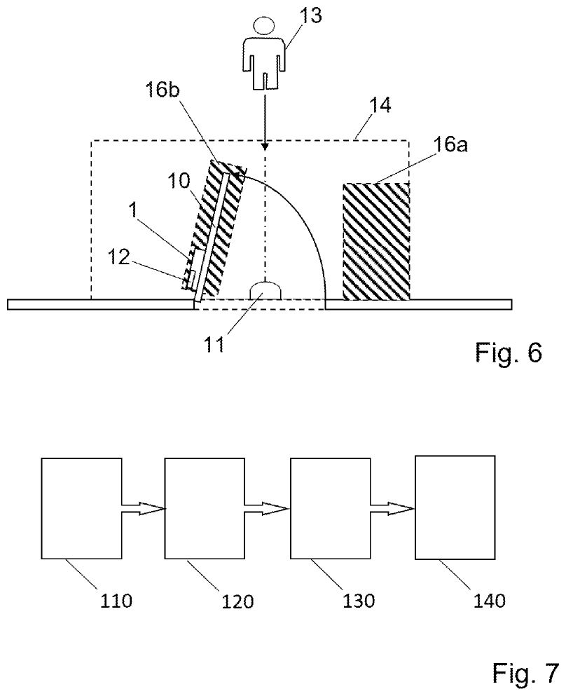

FIG. 6 shows a door leaf 10 in an open position, and a sensor unit 11 and a control unit 12 are shown. The object data of the sensor unit 11 is filtered out in a defined region of the detection region 14 by means of the control unit 12 such that a first static, to this extent immovable, hidden region 16a and a dynamic hidden region 16b, moving with the door leaf 10, are formed. According to the disclosure, the hidden regions 16a, 16b are calculated with the control unit 12 such that, for example, self-detection of the door leaf 10 is avoided when the sensor unit 11 is arranged stationary on the door system 100 and the door leaf 10 moves through the detection region. Only the object 13 is detected and the door leaf 10 is not.

FIG. 7 shows the method steps according to the disclosure in a simple diagram, which comprises the following: detecting 110 for the first time at least one first object position of the object within the detection region, detecting 120 for the second time at least one subsequent second object position of the object within the detection region, calculating 130 an object vector based on the detected first and second object positions, and opening 140 the at least one door leaf depending on the properties of the calculated object vector.

The design of the disclosure is not restricted to the preferred exemplary embodiment indicated above. In fact, a number of variants is conceivable which make use of the represented solution even in the case of fundamentally different designs. All features and/or advantages emerging from the claims, the description or the drawings, including constructive details or spatial arrangements, may be essential to the disclosure by themselves and in the most varied combinations.

1. A method for operating a door system with a door actuator, wherein the door system has at least one door leaf, and wherein a sensor unit is configured and connected to a control unit of the door system, wherein the approach of an object to the door system within a detection region is detected by the sensor unit, the method including at least the following steps:
determining for the first time at least one first object position of the object within the detection region,
determining for the second time at least one subsequent second object position of the object within the detection region,
calculating an object vector based on the determined first and second object positions, and
opening the at least one door leaf depending on the properties of the calculated object vector.

2. The method according to claim 1,
wherein opening the at least one door leaf is determined with an opening width and/or with an opening speed and/or at an opening time and/or with an opening hold time or subsequent closing time.

3. The method according to claim 1, wherein
the sensor unit comprises at least one radar sensor or is provided as a radar sensor and/or the sensor unit includes, without any further sensors, of precisely one radar sensor or of radar sensors.

4. The method according to claim 1,
wherein raw data is recorded with the sensor unit, having a number of points in a point field, wherein the determined first and second object positions are determined from the raw data by a computer unit of the sensor unit or the control unit, wherein the control unit carries out the calculation of the object vector from the at least two object positions.

5. The method according to claim 1,
wherein the sensor unit records two-dimensional raw data, comprising a number of points in a point field.

6. The method according to claim 1,
wherein the control unit or the sensor unit carries out the calculation of the object vector from two-dimensional object positions, in particular comprising object positions lying in one plane.

7. The method according to claim 1,
wherein the door system has at least one door leaf which is designed as a rotary leaf and performs a pivoting movement or has at least one door leaf designed as a sliding door leaf and performs a linear sliding movement when the door leaf is moved by the opening step.

8. The method according to claim 1,
wherein the calculating step of the object vector and/or the opening step of the door leaf is only carried out if the second object position is closer to the door leaf than the first object position, the direction of the object vector consequently points in the direction of the door system.

9. The method according to claim 1,
wherein deactivation data for deactivating the detection of at least one defined region of the detection region is provided to the sensor unit by means of the control unit and/or in that the control unit filters out, deletes the object data of the sensor unit in a defined region of the detection region, and/or hides a hidden region.

10. The method according to claim 9,
wherein the defined region, in particular the hidden region, is formed around the door leaf in order to avoid self-detection of the door leaf by the sensor unit.

11. The method according to claim 1,
wherein
the maximum opening width and/or the maximum opening speed and/or the opening time and/or the opening hold time or the subsequent closing time is determined by the control unit depending on the detected approach angle of the object
and/or in that
the opening speed of the door leaf is determined to be smaller when the object approaches the door system from the direction of the closing side than when the object approaches the door system from the direction of the hinge side, and wherein
the opening speed of the door leaf is determined to be greater when the object approaches the door system from the direction of the hinge side than when the object approaches the door system from the direction of the closing side.

12. A door actuator with a door system for carrying out a method according to claim 1.

13. The door system comprising at least one door actuator according to claim 12 and at least one door leaf.

14. A computer program product for carrying out a method according to claim 1 and/or for implementation in the control unit and/or the sensor unit of a door actuator of a door system.
